(19) United States
(12) Patent Application Publication
(10) Pub. No.: US 2025/0317202 A1
(43) Pub. Date: Oct. 9, 2025

(54) COMMUNICATION SYSTEM, SLAVE STATION APPARATUS, MASTER STATION APPARATUS AND PROCESSING METHOD

(71) Applicant: NIPPON TELEGRAPH AND TELEPHONE CORPORATION, Tokyo (JP)

(72) Inventors: Kazutaka HARA, Musashino-shi (JP); Yasunari TANAKA, Musashino-shi (JP); Takuya KANAI, Musashino-shi (JP); Junichi KANI, Musashino-shi (JP)

(73) Assignee: NIPPON TELEGRAPH AND TELEPHONE CORPORATION, Tokyo (JP)

(21) Appl. No.: 18/863,545

(22) PCT Filed: May 13, 2022
(86) PCT No.: PCT/JP2022/020251

§ 371 Date: Nov. 6, 2024

(51) Int. Cl. H04B 10/077; H04B 10/516; H04B 10/60

(52) U.S. Cl. CPC H04B 10/0775; H04B 10/516; H04B 10/60; H04B 2210/074

(57) ABSTRACT

A slave station device including: a superposition unit that is capable of superposing a main signal and a master station control signal by an electrical domain superposition method in which the main signal and the master station control signal for controlling a master station device connected to the slave station device are converted into an optical signal after multiplexing and an optical domain superposition method in which the main signal is modulated into an optical signal and then optically modulated by the master station control signal, and superposes the main signal and the master station control signal by any one of the electrical domain superposition method and the optical domain superposition method; and a control unit that controls the superposition method by the superposition unit on the basis of a slave station control signal indicating the superposition method received from the master station device.

### TECHNICAL FIELD

The present invention relates to a communication system, a slave station device, a master station device, and a processing method.

### BACKGROUND ART

In the International Telecommunication Union Telecommunication Standardization sector (ITU-T) G.989.2 recommendations, a PON system that performs wavelength multiplexing called point to point wavelength division multiplexing-PON (PtP WDM-PON) is defined (see Non Patent Literature 1). In the PtP WDM-PON system, a management control signal called an auxiliary management and control channel (AMCC) signal is used as a signal for management and control between an optical line terminal (OLT) and an optical network unit (ONU).

The AMCC signal is a signal superposed on a main signal and transmitted after information to be transmitted is modulated by a predetermined method, and is expected to be a kbps-order low-speed signal (see Non Patent Literature 2). The AMCC signal includes state information indicating, for example, a transmission and reception wavelength of an optical transceiver, a transmission optical intensity, a temperature, and the like.

Non Patent Literature 1 discloses two types of methods for superposing the AMCC signal. The first method is a method called “baseband modulation”. In the first method, the AMCC signal is superposed on the main signal to be transmitted by a baseband signal on a transmitter side, and the AMCC signal is separated by a low pass filter (LPF) or the like on a receiver side. The second method is a method called “low-frequency pilot tone”. In the second method, after the AMCC signal is up-converted to a frequency of a predetermined carrier wave and transmitted on the transmitter side, signal processing is performed to demodulate the signal on the receiver side.

In the second method, as a method of superposing the AMCC signal, there are an electrical domain superposition method and an optical domain superposition method. In the electrical domain superposition method, the main signal and the AMCC signal are multiplexed using an electrical coupler such as a combiner, and then the superposed electrical signal is converted into an optical signal using a laser diode (LD) or an optical modulator. In the optical domain superposition method, the AMCC signal is superposed on a modulated main signal using an optical modulator (see Non Patent Literature 3).

In addition, in order to enhance the power budget of an access network, an SOA integrated EML in which a semiconductor optical amplifier (SOA) is monolithically integrated as a post-amplifier in an electro-absorption modulator laser diode (EML-LD) has been reported (see Non Patent Literature 4 and 5). When the transmitter includes the SOA integrated EML, it is possible to select the electrical domain superposition method of superposing by an electro-absorption (EA) modulator and the optical domain superposition method of superposing by the SOA.

However, each of the two superposition methods has a disadvantage. In the electrical domain superposition method, it is necessary to keep a combined amplitude of the main signal and the AMCC signal within a range of transmission/absorption characteristics of EA, and an extinction ratio of the main signal decreases depending on a modulation degree (M value) of the AMCC signal, which may cause deterioration in the signal quality. In the optical domain superposition method, since the SOA is used as the modulator, an operation is performed in a linear domain of an optical output characteristic with respect to a bias current, and there is a possibility that waveform degradation due to a pattern effect and signal quality degradation due to a decrease in the optical output are caused.

### CITATION LIST

### Non Patent Literature

Non Patent Literature 1: “ITU-T G.989.2 Recommendation, “40-Gigabit-capable-passive optical networks (NG-PON2): Physical media dependent (PMD) layer specification,” February 2019.
Non Patent Literature 2: Y. Luo, H. Roberts, K. Grobe, M. Valvo, D. Nesset, K. Asaka, H. Rohde, J. Smith, J. S. Wey, and F. Effenberger, “Physical Layer Aspects of NG-PON2 Standards-Part 2:System Design and Technology Feasibility,” J. Opt. Com-mun. Netw., 8(1), pp. 43-52, January 2016.
Non Patent Literature 3: G. Nakagawa, K. Sone, S. Oda, S. Yoshida, Y. Hirose, M. Takizawa, and T. Hoshida, “Development of Evaluation Platform of AMCC Superimposition on CPRI Signal Transmission for Mobile Fronthaul Network,” in 2017 European Conference on Optical Communication (ECOC), Gothenburg, September 2017, pp. 1-3.
Non Patent Literature 4: Wataru Kobayashi et al., “Novel approach for chirp and output power compensation applied to a 40-Gbit/s EADFB laser integrated with a short SOA,” Opt. Express, vol. 23, no. 7, p. 9533, April 2015, doi: 10.1364/OE.23.009533.
Non Patent Literature 5: R. Rosales, I. Cano, D. Nesset, R. Brenot, N. Dubrovina, E. Duran-Valdeiglesias, H. Debregeas, “Achieving high budget classes in the downstream link of 50G-PON”, Journal of Optical Communications and Networking, vol. 13, no. 8, pp. D13-D21, 2021.

### SUMMARY OF INVENTION

### Technical Problem

An object of the present invention is to maintain the signal quality of a main signal and a control signal to be superposed at a suitable quality.

### Solution to Problem

An aspect of the present invention is a communication system including: a slave station device including a superposition unit that is capable of superposing a main signal and a master station control signal by an electrical domain superposition method with which the main signal and the master station control signal are multiplexed and then converted into an optical signal and an optical domain superposition method with which the main signal is modulated into an optical signal and then optically modulated by the master station control signal, superposes the main signal and the master station control signal by any one of the electrical domain superposition method and the optical domain superposition method, and transmits the superposed signal; a master station device including a signal quality measurement unit that measures, from two signals that have been received from the slave station device and one of which is the signal superposed by the electrical domain superposition method and the other is the signal superposed by the optical domain superposition method, a signal quality of the main signal and the master station control signal that have been superposed; and a superposition method determination unit that determines the electrical domain superposition method or the optical domain superposition method as the superposition method on the basis of the signal quality.

An aspect of the present invention is a slave station device including: a superposition unit that is capable of superposing a main signal and a master station control signal by an electrical domain superposition method in which the main signal and the master station control signal for controlling a master station device connected to the slave station device are converted into an optical signal after multiplexing and an optical domain superposition method in which the main signal is modulated into an optical signal and then optically modulated by the master station control signal, and superposes the main signal and the master station control signal by any one of the electrical domain superposition method and the optical domain superposition method; and a control unit that controls the superposition method by the superposition unit on the basis of a slave station control signal indicating the superposition method received from the master station device.

An aspect of the present invention is a master station device including: a signal quality measurement unit that measures, from two signals that have been received from a slave station device connected to the master station device and one of which is a signal superposed by an electrical domain superposition method with which a main signal and a master station control signal for controlling the master station device connected to the slave station device are multiplexed and then converted into an optical signal and the other is a signal superposed by an optical domain superposition method with which the main signal is modulated into an optical signal and then optically modulated by the master station control signal, a signal quality of the main signal and the master station control signal that have been superposed; a superposition method determination unit that determines the electrical domain superposition method or the optical domain superposition method as the superposition method on the basis of the signal quality; and a slave station control signal generation unit that generates a slave station control signal indicating the determined superposition method.

An aspect of the present invention is a processing method including: a superposition step of superposing a main signal and a master station control signal by any one of an electrical domain superposition method and an optical domain superposition method, the superposition method being capable of superposing the main signal and the master station control signal by the electrical domain superposition method in which the main signal and the master station control signal controlling a connected master station device are converted into an optical signal after multiplexing and the optical domain superposition method in which the main signal is modulated into an optical signal and then optically modulated by the master station control signal; and a control step of controlling the superposition method by the superposition step on the basis of a slave station control signal indicating the superposition method received from the master station device.

An aspect of the present invention is a processing method including: a signal quality measurement step of measuring, from two signals that have been received from a slave station device connected to a master station device and one of which is a signal superposed by an electrical domain superposition method with which a main signal and a master station control signal for controlling the master station device connected to the slave station device are multiplexed and then converted into an optical signal and the other is a signal superposed by an optical domain superposition method with which the main signal is modulated into an optical signal and then optically modulated by the master station control signal, a signal quality of the main signal and the master station control signal that have been superposed; a superposition method determination step of determining the electrical domain superposition method or the optical domain superposition method as the superposition method on the basis of the signal quality; and a slave station control signal generation step of generating a slave station control signal indicating the determined superposition method.

### Advantageous Effects of Invention

With the present invention, the signal quality of the main signal and the control signal to be superposed is maintained at a suitable quality.

### BRIEF DESCRIPTION OF DRAWINGS

FIG. 1 is a diagram illustrating a communication system 1 according to a first embodiment.

FIG. 2 is a diagram illustrating an example of a configuration of a slave station device 2 according to the first embodiment.

FIG. 3 is a diagram illustrating an example of a configuration of a master station device 3 according to the first embodiment.

FIG. 4 is an example of signal quality (bit error rate (BER)) of a recorded main signal and master station control signal.

FIG. 5 is a sequence diagram illustrating an operation of determining a superposition method of the slave station device 2.

FIG. 6 is a diagram illustrating the communication system 1 according to a second embodiment.

FIG. 7 is a diagram illustrating a recorded signal quality.

FIG. 8 is a diagram illustrating an example of a configuration of a master station device 3 according to a third embodiment.

FIG. 9 is a diagram illustrating the communication system 1 according to a fourth embodiment.

FIG. 10 is a diagram illustrating the communication system 1 according to a fifth embodiment.

FIG. 11 is a diagram illustrating an example of a modification of the communication system 1 according to the fifth embodiment.

### DESCRIPTION OF EMBODIMENTS

### First Embodiment

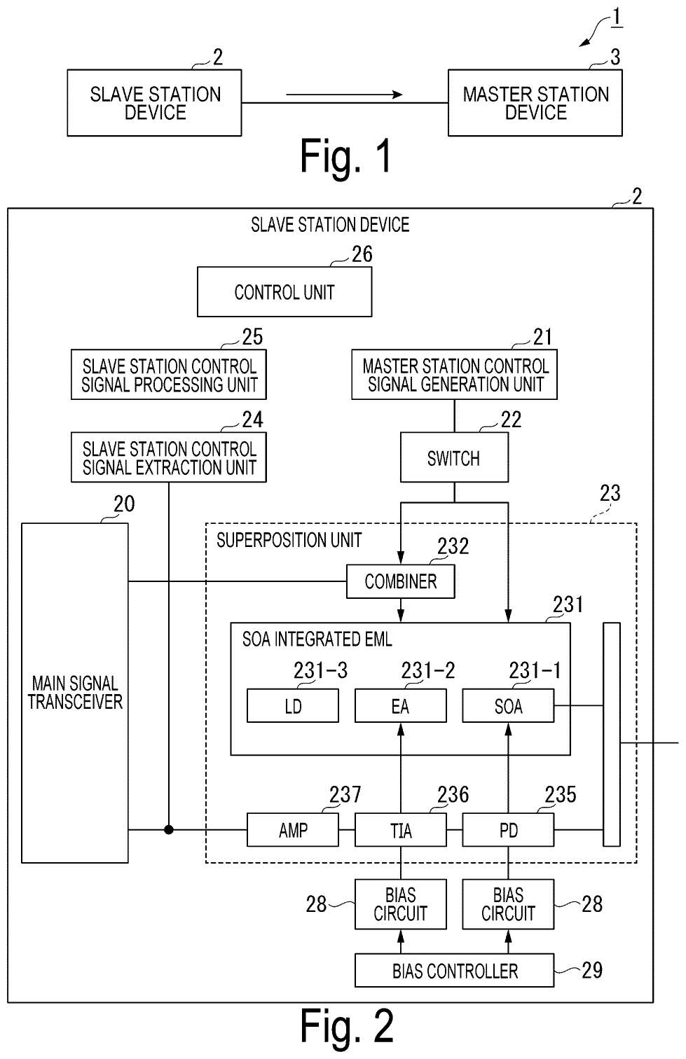

Embodiments of the present invention will be described in detail below with reference to the drawings. FIG. 1 is a diagram illustrating a communication system 1 according to a first embodiment. The communication system 1 includes a slave station device 2 and a master station device 3. In the communication system 1 according to the first embodiment, the slave station device 2 and the master station device 3 are connected by an optical fiber in a point-to-point manner.

FIG. 2 is a diagram illustrating an example of a configuration of the slave station device 2 according to the first embodiment. The slave station device 2 includes a main signal transceiver 20, a master station control signal generation unit 21, a switch 22, a superposition unit 23, a slave station control signal extraction unit 24, a slave station control signal processing unit 25, a control unit 26, a bias controller 29, and a bias circuit 28. The superposition unit 23 includes an SOA integrated EML 231, a combiner 232, a photo diode (PD) 235, a transimpedance amplifier (TIA) 236, and an amplifier (AMP) 237.

The main signal transceiver 20 transmits and receives a main signal via the superposition unit 23. The main signal transceiver 20 may transmit a test pattern for determining a superposition method by the superposition unit 23.

The master station control signal generation unit 21 generates a master station control signal which is a control signal for controlling the master station device 3. The generated master station control signal is input to the combiner 232 or an SOA 231-1 of the SOA integrated EML 231 via the switch 22. When the master station control signal is input to the combiner 232, the main signal and the master station control signal are multiplexed by the combiner 232, input to an EA 231-2 of the SOA integrated EML 231, and transmitted to the master station device 3 without being modulated by the SOA 231-1. That is, the main signal and the master station control signal are superposed by an electrical domain superposition method. When the master station control signal is input to the SOA 231-1 of the SOA integrated EML 231, the main signal input to the SOA 231-1 via the combiner 232 and the EA 231-2 is optically modulated by the SOA 231-1 on the basis of the master station control signal. That is, the main signal and the master station control signal are superposed by an optical domain superposition method.

When the main signal transceiver 20 transmits the test pattern for determining the superposition method by the superposition unit 23, the master station control signal may include a bit string indicating the superposition method by the superposition unit 23.

An optical signal transmitted from the master station device 3 is input to the superposition unit 23. The optical signal input to the superposition unit 23 is converted into an electrical signal by the PD 235, a current is converted into a voltage by the TIA 236, and an amplitude is equivalently amplified by the AMP 237. Thereafter, the signal amplified by the AMP 237 is input from the superposition unit 23 to the main signal transceiver 20 and the slave station control signal extraction unit 24.

The slave station control signal extraction unit 24 extracts a slave station control signal from the electrical signal. The slave station control signal extraction unit 24 includes, for example, a low pass filter, and extracts the slave station control signal from the electrical signal. The slave station control signal is, for example, a control signal indicating the superposition method by the superposition unit 23.

The slave station control signal processing unit 25 processes the extracted slave station control signal. The control unit 26 controls the slave station device 2 on the basis of the slave station control signal. The control unit 26 switches the switch 22 to allow, for example, the superposition unit 23 to perform the superposition method indicated by the slave station control signal. In addition, the control unit 26 controls the bias circuit 28 via the bias controller 29 to control a bias of the EA 231-2 and the SOA 231-1.

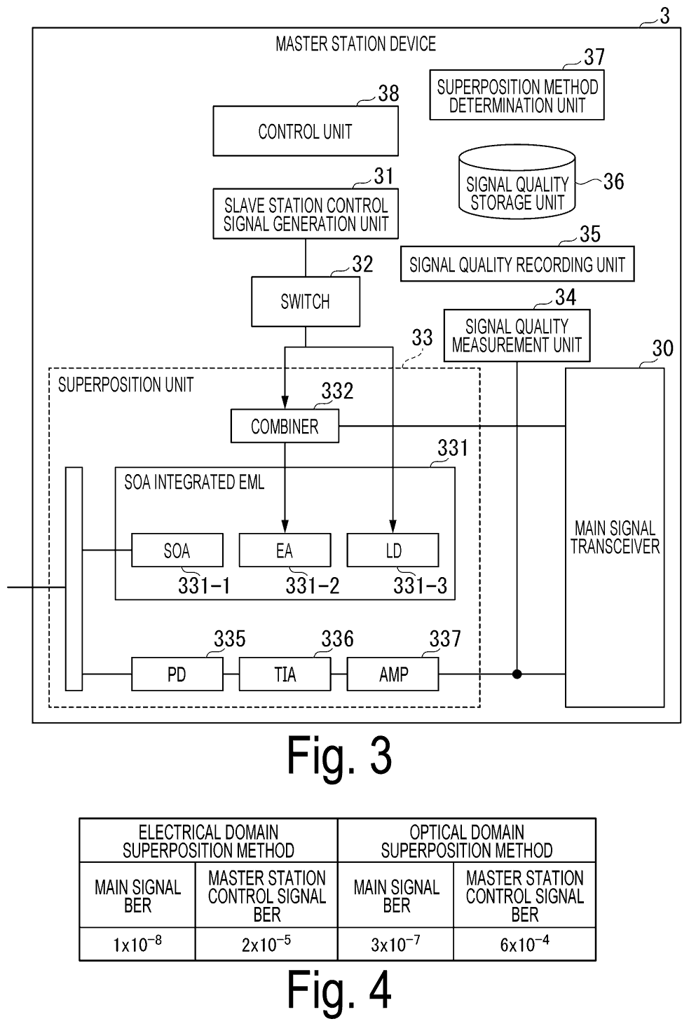

FIG. 3 is a diagram illustrating an example of a configuration of the master station device 3 according to the first embodiment. The master station device 3 includes a main signal transceiver 30, a slave station control signal generation unit 31, a signal quality measurement unit 34, a signal quality recording unit 35, a signal quality storage unit 36, a superposition method determination unit 37, and a control unit 38.

The main signal transceiver 30 transmits and receives the main signal via a superposition unit 33.

The slave station control signal generation unit 31 generates the slave station control signal which is the control signal for controlling the slave station device 2. The slave station control signal indicates the determined superposition method and is transmitted to the slave station device 2. The generated slave station control signal is input to a combiner 332 or an SOA of an SOA integrated EML 331 via the switch 32. When the slave station control signal is input to the combiner 232, the main signal and the slave station control signal are multiplexed by the combiner 232, input to an EA of the SOA integrated EML 331, and transmitted to the slave station device 2 without being modulated by the SOA. That is, the main signal and the slave station control signal are superposed by the electrical domain superposition method. When the slave station control signal is input to the SOA of the SOA integrated EML 331, the main signal input to the SOA via the combiner 332 and the EA is optically modulated by the SOA on the basis of the slave station control signal. That is, the main signal and the slave station control signal are superposed by the optical domain superposition method.

The optical signal transmitted from the slave station device 2 is input to the superposition unit 33. The optical signal input to the superposition unit 33 is converted into an electrical signal by a PD 335, the current is converted into a voltage by a TIA 336, and the amplitude is equivalently amplified by an AMP 337. Thereafter, the electrical signal is input from the superposition unit 33 to the main signal transceiver 20 and the signal quality measurement unit 34.

The signal quality measurement unit 34 measures the signal quality of the main signal and the master station control signal from the electrical signal. The signal quality measurement unit 34 includes, for example, a low pass filter, extracts the master station control signal from the electrical signal, and measures the signal quality of the master station control signal. The signal quality is, for example, a BER or a packet error rate (PER). In addition, the signal quality measurement unit 34 processes the bit string included in the master station control signal and indicating the superposition method by the superposition unit 23, and determines whether the signal is superposed by the electrical domain superposition method or the optical domain superposition method.

The signal quality recording unit 35 records the superposition method and the signal quality of the main signal and the master station control signal in the signal quality storage unit 36. FIG. 4 is an example of the signal quality (BER) of the recorded main signal and master station control signal.

The superposition method determination unit 37 determines the superposition method on the basis of the signal quality recorded in the signal quality storage unit 36. The superposition method determination unit 37 may determine a superposition method in which the signal quality of the main signal is high, may determine a superposition method in which the signal quality of the master station control signal is high, or may determine a superposition method in which the signal quality of the main signal or the master station control signal is a value close to a predetermined signal quality.

The control unit 38 controls the master station device 3. The control unit 38 causes the slave station control signal generation unit 31 to generate a control signal indicating the superposition method determined by the superposition method determination unit 37, for example.

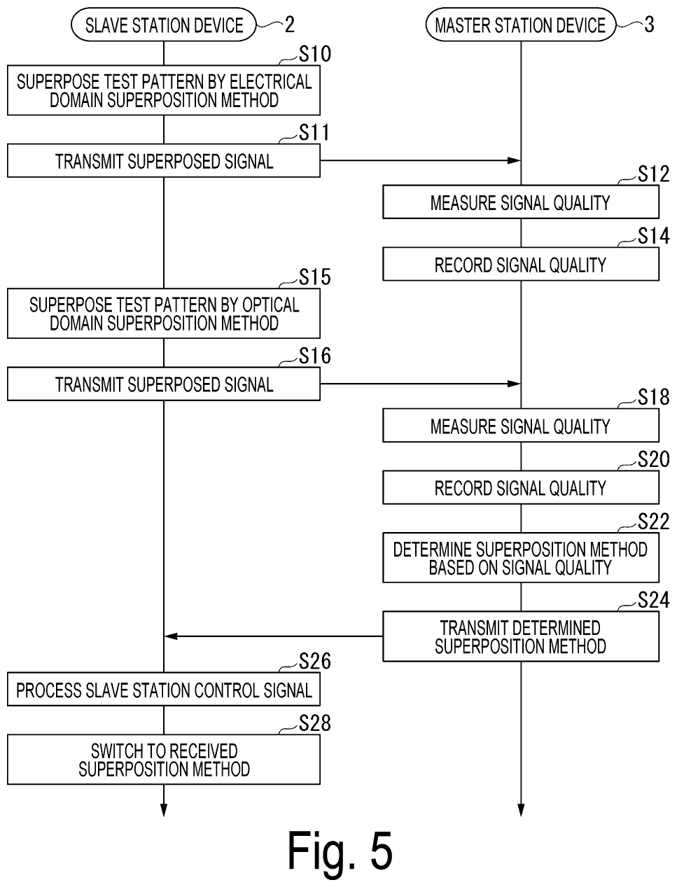

FIG. 5 is a sequence diagram illustrating an operation of determining a superposition method of the slave station device 2.

First, the superposition unit 23 of the slave station device 2 superposes the main signal of the test pattern and the master station control signal by the electrical domain superposition method (step S10). Thereafter, the superposition unit 23 transmits the superposed signal to the master station device 3 (step S11). The signal quality of the main signal and the master station control signal included in the signal received by the signal quality measurement unit 34 of the master station device 3 are measured (step S12). The signal quality recording unit 35 records the measured signal quality (step S14).

Thereafter, the superposition unit 23 of the slave station device 2 superposes the main signal of the test pattern and the master station control signal by the optical domain superposition method (step S15). Thereafter, the superposition unit 23 transmits the superposed signal to the master station device 3 (step S16). The signal quality of the main signal and the master station control signal included in the signal received by the signal quality measurement unit 34 of the master station device 3 are measured (step S18). The signal quality recording unit 35 records the measured signal quality (step S20).

Note that the signal quality measurement unit 34 determines by which of the electrical domain superposition method and the optical domain superposition method the superposed signal is by processing the bit string included in the master station control signal and indicating the superposition method by the superposition unit 23. Therefore, the slave station device 2 may superpose the main signal of the test pattern and the master station control signal by the optical domain superposition method, and then superpose the main signal of the test pattern and the master station control signal by the electrical domain superposition method.

The superposition method determination unit 37 determines the superposition method on the basis of the recorded signal quality (step S22). The slave station control signal generation unit 31 generates a slave station control signal indicating the determined superposition method, and the slave station control signal is transmitted to the slave station device 2 (step S24).

The slave station control signal received by the slave station device 2 is extracted by the slave station control signal extraction unit 24 and processed by the slave station control signal processing unit 25 (step S26). Thereafter, the control unit 26 switches the switch 22 on the basis of the slave station control signal (step S28). As a result, the superposition method of the superposition unit 23 is determined.

As described above, in the first embodiment, the slave station device 2 superposes the control signal on the main signal by two different superposition methods and transmits the superposed signal to the master station device 3. The master station device 3 measures the signal quality of signals superposed by different superposition methods, and determines the superposition method on the basis of the measured signal quality. As a result, the signal quality of the superposed main signal and control signal can be maintained in the best state.

### Second Embodiment

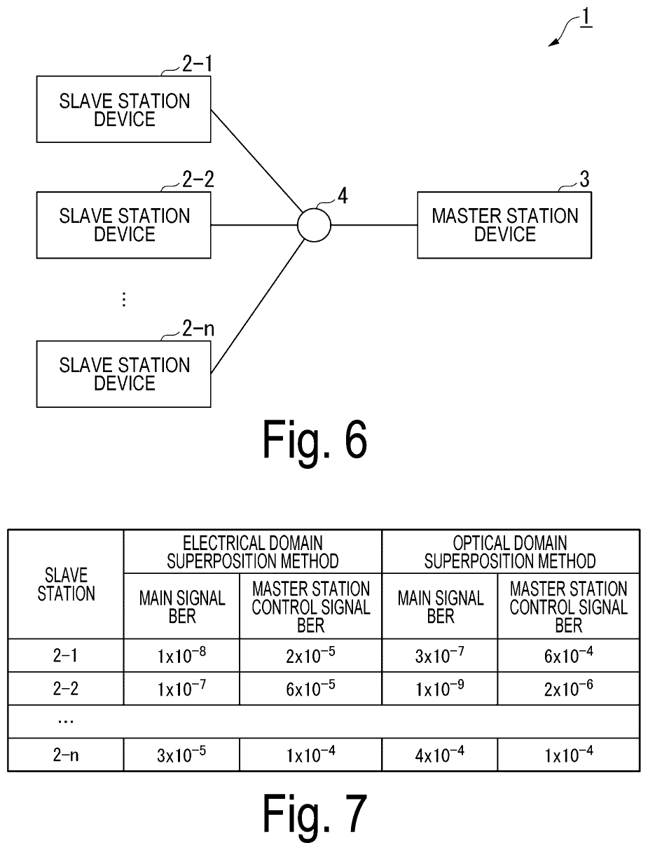

FIG. 6 is a diagram illustrating the communication system 1 according to a second embodiment. The communication system 1 according to the second embodiment includes n (n is an integer of 2 or more) slave station devices 2-1 to n, one master station device 3, and an optical splitter 4. The communication system 1 according to the second embodiment is a time division multiplexing (TDM)/time division multiple access (TDMA)-based network in which the slave station device 2 and the master station device 3 are connected via a passive device such as the optical splitter 4 that distributes optical intensity.

The configurations of the slave station device 2 and the master station device 3 are the same as those of the slave station device 2 and the master station device 3 according to the first embodiment, respectively. Each slave station device 2 transmits the test pattern superposed by time division multiplexing to the master station device 3. The signal quality measurement unit 34 of the master station device 3 measures the signal quality of the main signal and the master station control signal based on two superposition methods for each slave station. The signal quality recording unit 35 records a signal quality for each slave station. FIG. 7 is a diagram illustrating a recorded signal quality. The superposition method determination unit 37 determines a superposition method for each slave station device 2.

As described above, also in the TDM/TDMA-based network in which the slave station device 2 and the master station device 3 are connected via a passive device such as the optical splitter 4 as in the second embodiment, the signal quality of the main signal and the control signal to be superposed can be similarly maintained in the best state.

### Third Embodiment

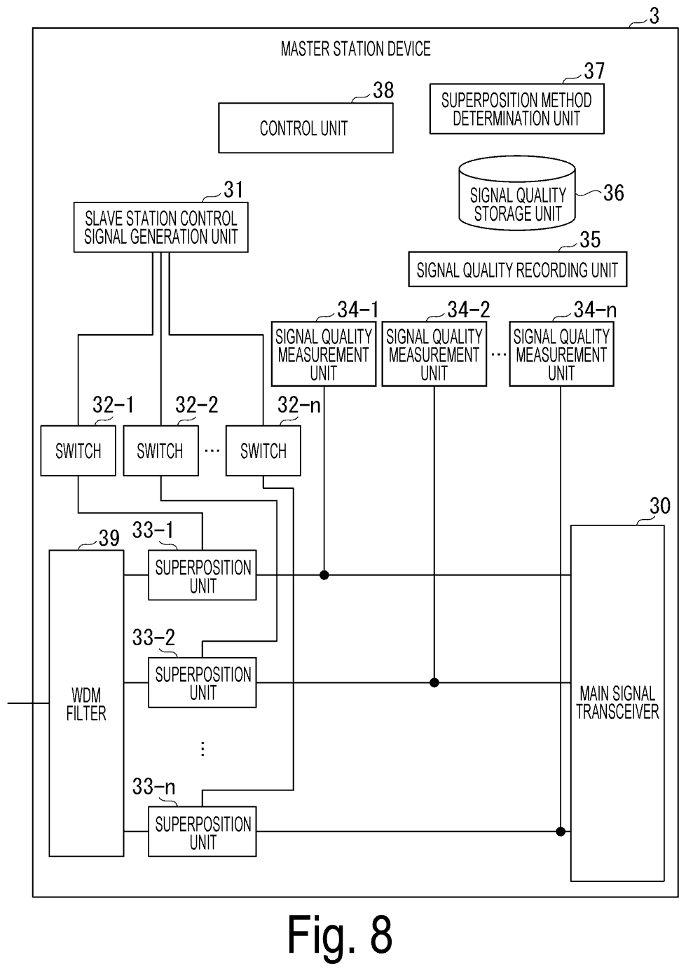

The communication system 1 according to a third embodiment is a WDM-based network including n (n is an integer of 2 or more) slave station devices 2-1 to n, one master station device 3, and the optical splitter 4. The configuration of the communication system 1 according to the third embodiment is the same as that of the communication system 1 according to the second embodiment. FIG. 8 is a diagram illustrating an example of a configuration of a master station device 3 according to the third embodiment. Unlike the master station device 3 according to the second embodiment, the master station device 3 according to the third embodiment includes n switches 32, the superposition unit 33, and the signal quality measurement unit 34. In addition, the master station device 3 according to the third embodiment includes a WDM filter 39.

In the third embodiment, different wavelengths are allocated to an uplink signal transmitted from the slave station device 2 to the master station device 3 and a downlink signal transmitted from the master station device 3 to the slave station device 2 for each slave station device 2 and for each of the uplink signal and the downlink signal. The signal input from each slave station device 2 to the master station device 3 is demultiplexed by a WDM filter 39 and input to the superposition unit 33 corresponding to the wavelength of the signal. Thereafter, the signal quality measurement unit 34 measures a signal quality for each signal having a different wavelength.

The number of signal quality measurement units 34 may be one as long as a buffer is provided between the AMP 337 of the superposition unit 33 and the main signal transceiver 30 and the signals can be processed in order.

### Fourth Embodiment

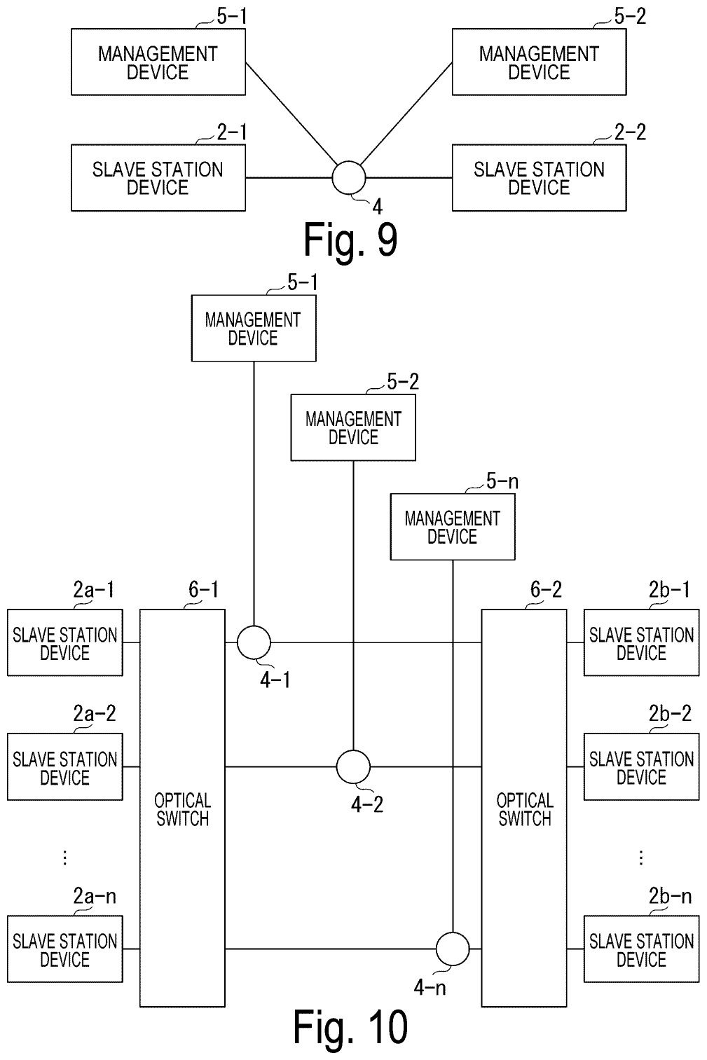

FIG. 9 is a diagram illustrating the communication system 1 according to a fourth embodiment. The communication system 1 according to the fourth embodiment includes a couple of the slave station devices 2 (2-1 and 2-2), a couple of the management devices 5 (5-1 and 5-2), and the optical splitter 4. In the communication system 1 according to the fourth embodiment, the slave station device 2-1 and the slave station device 2-2 transmit and receive a main signal and a control signal. The management device 5 has a configuration similar to that of the master station device 3, but superposes the control signal on a continuous wave and transmits the superposed signal.

The management device 5-2 measures a signal quality of the signal transmitted from the slave station device 2-1, determines a superposition method, and generates a slave station control signal. In addition, the management device 5-1 measures a signal quality of the signal transmitted from the slave station device 2-2, determines a superposition method, and generates a slave station control signal.

Here, since both the slave station device 2-1 and the management device 5-1 transmit signals to the slave station device 2-2, it is desirable that the wavelengths of the signals to be transmitted are different in order to prevent interference. Similarly, it is desirable that the wavelengths of the signals transmitted by the slave station device 2-2 and the management device 5-2 are also different.

The communication system 1 according to the fourth embodiment includes the management device 5 corresponding to each slave station device 2, but is not limited thereto. For example, in a case where two slave station devices 2 transmit and receive signals of the same wavelength and output the signals in a time division manner, one management device 5 may be connected to the optical splitter 4, and the management device 5 may transmit slave station control signals to the slave station devices 2-1 and 2-2. In addition, when the communication system 1 according to the fourth embodiment is the WDM-based network, similarly to the third embodiment, the management device 5 may include the WDM filter 39, the superposition unit 33, or the signal quality measurement unit 34 having different corresponding wavelengths.

FIG. 10 is a diagram illustrating the communication system 1 according to the fifth embodiment. The communication system 1 according to the fifth embodiment includes slave station devices 2a-1 to n and 2b-1 to n, management devices 5-1 to n, optical splitters 4-1 to n, and optical switches 6-1 and 2.

The slave station devices 2a and 2b according to the fifth embodiment have the same configuration as the slave station device 2 according to the fourth embodiment. The management device 5 according to the fifth embodiment has the same configuration as the management device 5 according to the fourth embodiment. The optical switch 6-1 is provided between the slave station devices 2a and the optical splitters 4. The optical switch 6-2 is provided between the slave station devices 2b and the optical splitters 4. The optical switches 6-1 and 2 are controlled by control signals superposed on signals transmitted from the management devices 5, and change paths.

For example, the master station control signal transmitted from the slave station device 2a-1 includes a bit string indicating the slave station device 2b of a transmission destination of the slave station device 2a-1. The management device 5-1 receives the master station control signal from the slave station device 2a-1 via the optical splitter 4-1. The signal quality measurement unit 34 of the management device 5-1 determines the transmission destination of the slave station device 2a-1 by processing the bit string included in the master station control signal and indicating the slave station device 2b of the transmission destination of the slave station device 2a-1. Thereafter, the management device 5-1 transmits a control signal including information indicating the transmission destination of the slave station device 2a-1 to the optical switches 6-1 and 6-2. The optical switches 6-1 and 6-2 are switched based on the control signal transmitted from the management device 5-1.

Similarly to the slave station device 2a-1, the slave station device 2b-1 may transmit the master station control signal to the management device 5-1. In addition, similarly to the slave station device 2a-1, the other slave station devices 2a and 2b may transmit the master station control signal to the management devices 5.

Similarly to the fourth embodiment, signals transmitted from the slave station devices 2a and 2b are input to the management devices 5 connected to the optical splitters 4, a signal quality is measured, and a superposition method is determined.

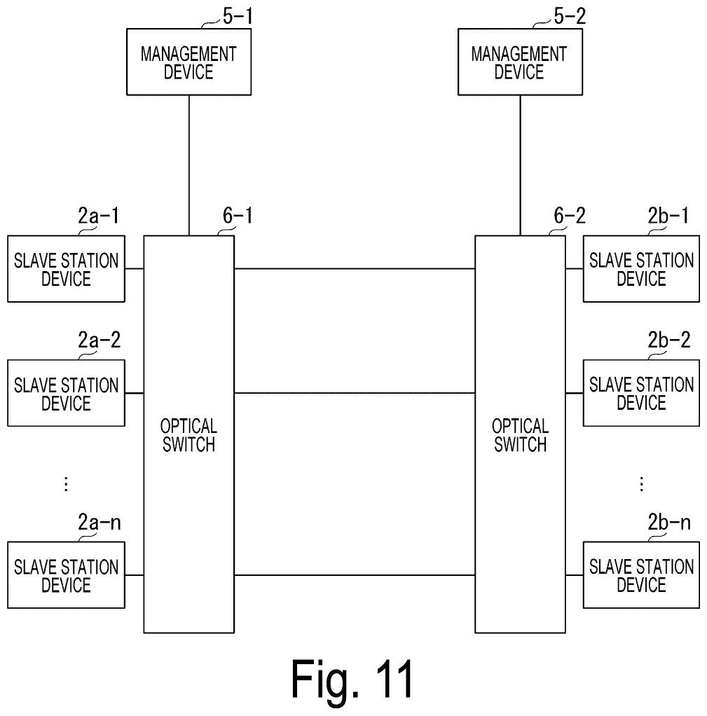

FIG. 11 is a diagram illustrating a modification of the communication system 1 according to the fifth embodiment. The communication system 1 according to the fifth embodiment may include no optical splitter 4, and each of the optical switches 6-1 and 2 may be connected to the management devices 5-1 and 2. At this time, the signal transmitted from the slave station device 2a can be output to the management device 5-1 via the optical switch 6-1. The signal transmitted from the slave station device 2b can be output to the management device 5-2 via the optical switch 6-2.

For example, in an initial state, all the slave station devices 2a are connected to the management device 5-1 via the optical switch 6-1, and all the slave station devices 2b are connected to the management device 5-2 via the optical switch 6-2. The slave station device 2a transmits the master station control signal including a bit string indicating the slave station device 2b of the transmission destination of the slave station device 2a to the management device 5-1. The signal quality measurement unit 34 of the management device 5-1 determines the transmission destination of the slave station device 2a by processing the bit string included in the master station control signal and indicating the slave station device 2b of the transmission destination of the slave station device 2a. Thereafter, the management device 5-1 transmits a control signal including information indicating the transmission destinations of the slave station devices 2a to the optical switch 6-1. The optical switch 6-1 is switched based on the control signal transmitted from the management device 5-1.

The slave station device 2b and the optical switch 6-2 operate similarly to the slave station device 2a and the optical switch 6-1.

### REFERENCE SIGNS LIST

1 Communication system
2 Slave station device
3 Master station device
4 Optical splitter
5 Management device
6 Optical switch
20 Main signal transceiver
21 Master station control signal generation unit
22 Switch
23 Superposition unit
24 Slave station control signal extraction unit
25 Slave station control signal processing unit
26 Control unit
30 Main signal transceiver
31 Slave station control signal generation unit
32 Switch
33 Superposition unit
34 Signal quality measurement unit
35 Signal quality recording unit
36 Signal quality storage unit
37 Superposition method determination unit
38 Control unit
39 WDM filter

1. A communication system comprising:
a slave station apparatus including
a superposer capable of superposing a main signal and a master station control signal by an electrical domain superposition method with which the main signal and the master station control signal are multiplexed and then converted into an optical signal and an optical domain superposition method with which the main signal is modulated into an optical signal and then optically modulated by the master station control signal, superposes the main signal and the master station control signal by any one of the electrical domain superposition method and the optical domain superposition method, and transmits the superposed signal;
a master station apparatus including
a signal quality measurer configured to measure, from two signals that have been received from the slave station apparatus and one of which is the signal superposed by the electrical domain superposition method and the other is the signal superposed by the optical domain superposition method, a signal quality of the main signal and the master station control signal that have been superposed; and
a superposition method determiner configured to determine the electrical domain superposition method or the optical domain superposition method as the superposition method on the basis of the signal quality.

2. A slave station apparatus comprising:
a superposer capable of superposing a main signal and a master station control signal by an electrical domain superposition method in which the main signal and the master station control signal are converted into an optical signal after multiplexing and an optical domain superposition method in which the main signal is modulated into an optical signal and then optically modulated by the master station control signal, and superposes the main signal and the master station control signal by any one of the electrical domain superposition method and the optical domain superposition method; and
a controller configured to control the superposition method by the superposer on the basis of a slave station control signal indicating the superposition method having been received.

3. A master station apparatus comprising:
a signal quality measurer configured to measure, from two signals that have been received from a slave station apparatus connected to the master station apparatus and one of which is a signal superposed by an electrical domain superposition method with which a main signal and a master station control signal for controlling the master station apparatus connected to the slave station apparatus are multiplexed and then converted into an optical signal and the other is a signal superposed by an optical domain superposition method with which the main signal is modulated into an optical signal and then optically modulated by the master station control signal, a signal quality of the main signal and the master station control signal that have been superposed;
a superposition method determiner configured to determine the electrical domain superposition method or the optical domain superposition method as the superposition method on the basis of the signal quality; and
a slave station control signal generator configured to generate a slave station control signal indicating the determined superposition method.

4. (canceled)

5. (canceled)

6. A communication system comprising:
a plurality of the slave station apparatuses according to claim 2; and
a single apparatus of the master station apparatus, wherein the master station apparatus includes
a signal quality measurer configured to measure, from two signals that have been received from each of the plurality of the slave station apparatus and one of which is the signal superposed by the electrical domain superposition method and the other is the signal superposed by the optical domain superposition method, a signal quality of the main signal and the master station control signal that have been superposed;
a superposition method determiner configured to determine the electrical domain superposition method or the optical domain superposition method as the superposition method on the basis of the signal quality for each of the plurality of the slave station apparatus; and
a slave station control signal generator configured to generate a slave station control signal indicating the determined superposition method for each of the plurality of the slave station apparatus.

7. A communication system comprising:
a plurality of the slave station apparatuses according to claim 2; and
a single apparatus of the master station apparatus, wherein the master station apparatus includes
a signal quality measurer configured to measure, from two signals that have been received from each of the plurality of the slave station apparatus and one of which is the signal superposed by the electrical domain superposition method and the other is the signal superposed by the optical domain superposition method, a signal quality of the main signal and the master station control signal that have been superposed;
a superposition method determiner configured to determine the electrical domain superposition method or the optical domain superposition method as the superposition method on the basis of the signal quality for each of the plurality of the slave station apparatus; and
a slave station control signal generator configured to generate a slave station control signal indicating the determined superposition method for each of the plurality of the slave station apparatus,
wherein the plurality of the slave station apparatus and the master station apparatus are connected by a WDM-based network,
the master station apparatus demultiplexes signals input from the signal quality measurement unit and the slave station apparatuses as many as the number of the slave station apparatuses and includes a WDM filter, and the signal quality measurement unit measures each signal demultiplexed by the WDM filter.

8. A communication system comprising:
a couple of the slave station apparatuses according to claim 2; and
a couple of management apparatuses, wherein the management apparatus includes
a signal quality measurer configured to measure, from two signals that have been received from the slave station apparatus and one of which is the signal superposed by the electrical domain superposition method and the other is the signal superposed by the optical domain superposition method, a signal quality of the main signal and the master station control signal that have been superposed;
a superposition method determiner configured to determine the electrical domain superposition method or the optical domain superposition method as the superposition method on the basis of the signal quality; and
a slave station control signal generator configured to generate a slave station control signal indicating the determined superposition method,
wherein a first slave station apparatus included in the slave station apparatuses outputs a signal to a first management apparatus included in the management apparatuses,
the first management apparatus measures a signal quality of a signal input from the first slave station apparatus, determines a superposition method, and generates a slave station control signal,
a second slave station apparatus different from the first slave station apparatus outputs a signal to a second management device different from the first management apparatus, and
the second management apparatus measures a signal quality of a signal input from the second slave station apparatus, determines a superposition method, and generates a slave station control signal.
